(19) United States
(12) Patent Application Publication
(10) Pub. No.: US 2006/0277563 A1
(43) Pub. Date: Dec. 7, 2006

(54) Hologram medium cartridge

(75) Inventors: Atsushi Sato, Ibaraki (JP); Minoru Fujita, Ibaraki (JP)

Correspondence Address: BIRCH STEWART KOLASCH & BIRCH, PO BOX 747, FALLS CHURCH, VA, 22040-0747, US

(73) Assignee: HITACHI MAXELL, LTD.

(21) Appl. No.: 11/443,218

(22) Filed: May 31, 2006

(30) Foreign Application Priority Data
Jun. 1, 2005 (JP) 2005-161565

(51) Int. Cl. G11B 23/03

(52) U.S. Cl. 720/725

(57) ABSTRACT

In order to provide a more practical, thin and lightweight hologram medium cartridge, a cartridge case is provided with a hologram accommodating recess for accommodating a holographic recording material, the holographic recording material is accommodated in the recess, and a surface of the holographic recording material accommodated in the recess is covered with a transparent substrate. It is possible to make the hologram medium cartridge thinner and more lightweight by one substrate, in comparison with the case in which the holographic recording material sandwiched between two substrates is accommodated in the cartridge case.

### BACKGROUND OF THE INVENTION

1. Field of the Invention

The present invention relates to a hologram medium cartridge, and particularly to the structure for accommodating a holographic recording material in a cartridge case.

2. Description of the Prior Art

In recent years, a hologram medium using a hologram attracts attention as an information storage carrier because it has a significantly higher capacity for storing information than that of an optical disk such as a CD or a DVD and further, it is not necessary to rotationally drive the medium at high speed, which makes it possible to omit or simplify a medium driving system of a recording and reproducing apparatus.

Basically, the hologram medium has the structure in which a hologram recording layer is sandwiched between two substrates. Then, in order to prevent deterioration of the hologram recording layer due to exposure, the technique for accommodating the hologram medium in a light-shielding cartridge case has been conventionally proposed (see JP-A-2003-317422, for example).

### BRIEF SUMMARY OF THE INVENTION

However, in the case of the structure in which a cartridge case accommodates a hologram medium in which a holographic recording material is simply sandwiched between two substrates, there is a disadvantage that the hologram medium cartridge becomes thick and heavy.

Accordingly, the present invention is made to solve the imperfection in the prior art, and the object is to provide a more practical hologram medium cartridge of a thin and lightweight type.

In order to solve the above described problem, the present invention provides a hologram medium cartridge in which a holographic recording material is accommodated in a cartridge case, which cartridge is configured so that the cartridge case is provided with a hologram accommodating recess for accommodating the holographic recording material, the holographic recording material is accommodated in the recess, a surface of the holographic recording material accommodated in the recess is covered with a transparent substrate, and a cartridge surface is covered with a movable shutter member for preventing dust, particles, fingerprints or the like, which may cause failure in recording and reproducing, from sticking to the transparent substrate. In addition, by forming the shutter member out of dark color resin such as black resin, or by applying dark color paint such as black paint to a surface of the shutter member made of metal or resin, it is possible to prevent an unrecorded holographic recording material from being exposed. By the configuration in which a rib is provided on an end of the shutter, the configuration in which the shutter structure shrouds the hologram medium including the above described transparent substrate, or the configuration in which a rib is provided on an end of the shutter and the shutter structure shrouds the hologram medium including the above described transparent substrate, the sticking of the dust and the particles, and easily entry of the light are structurally prevented.

According to the configurations, since a bottom surface of the hologram accommodating recess substitutes for one of the substrates constituting the hologram medium, one of the substrates constituting the hologram medium can be omitted and thus it becomes possible to reduce the thickness and the weight of the hologram medium cartridge. In addition, because one of the substrates can be omitted, cost reduction of the hologram medium cartridge can be achieved as a result of decrease in the number of parts and in the number of assembling processes.

Further, the present invention configures the hologram medium cartridge having the above described configuration so that a substrate accommodating recess is formed on the periphery of the hologram accommodating recess for fitting a periphery of the substrate thereto.

According to this configuration, since not only the holographic recording material but also the substrate can be embedded in the cartridge case, it becomes possible to further reduce the thickness of the hologram medium cartridge. In addition, since the substrate accommodating recess works as a positioning means for the substrate when the hologram medium is assembled in the cartridge case, it is possible to facilitate the assembling of the hologram medium cartridge.

Further, the present invention configures the hologram medium cartridge having the above described configuration so that a hologram storing recess which communicates with the hologram accommodating recess is formed in the cartridge case for accommodating a residual holographic recording material.

According to this configuration, since the hologram storing recess works as an escape portion for the residual holographic recording material, even if the volume of the holographic recording material injected into the hologram accommodating recess varies in some degree, it is always possible to form the holographic recording material having a uniform thickness over the entire surface of the hologram accommodating recess, and consequently, the hologram medium cartridge having required recording characteristics can be manufactured with high yield ratio.

Further, the present invention configures the hologram medium cartridge having the above described configuration so that a reference location mark is formed on a top surface of the cartridge case for indicating a recording location of information on the holographic recording material.

According to this configuration, since it is possible to record information onto the holographic recording material accommodated in the cartridge case and to reproduce the information recorded on the holographic recording material with reference to the reference location mark formed on the top surface of the cartridge case, the recording and the reproducing of the information can be performed with high accuracy and high efficiency.

In a hologram medium cartridge according to the present invention, a cartridge case is provided with a hologram accommodating recess for accommodating a holographic recording material, the holographic recording material is accommodated in the recess, and a surface of the holographic recording material accommodated in the recess is covered with a transparent substrate. Thus, it is possible to omit one of substrates constituting the hologram medium, and to achieve reduction in thickness and in weight of the hologram medium cartridge. In addition, because one of the substrates constituting the hologram medium can be omitted, cost reduction of the hologram medium cartridge can be achieved as a result of decrease in the number of parts and in the number of assembling processes.

The other objects, characteristics and advantages of the present invention will become apparent from the description of the embodiments of the present invention relating to the attached drawings.

### BRIEF DESCRIPTION OF THE SEVERAL VIEWS OF THE DRAWINGS

FIG. 1 is a plane view of a hologram medium cartridge according to an embodiment;

FIG. 2 is a back view of the hologram medium cartridge according to the embodiment;

FIG. 3 is a side view of the hologram medium cartridge according to the embodiment;

FIG. 4 is an end view of the hologram medium cartridge according to the embodiment;

FIG. 5 is a cross-sectional view along A-A in FIG. 1;

FIG. 6 is a cross-sectional view along B-B in FIG. 1;

FIG. 7 is a cross-sectional view along C-C in FIG. 2;

FIG. 8 is a cross-sectional view along D-D in FIG. 2;

FIG. 9 is a perspective view of the hologram medium cartridge according to the embodiment; and

FIG. 10 is a plane view of the hologram medium cartridge according to the embodiment in a shutter open state.

### DETAILED DESCRIPTION OF THE INVENTION

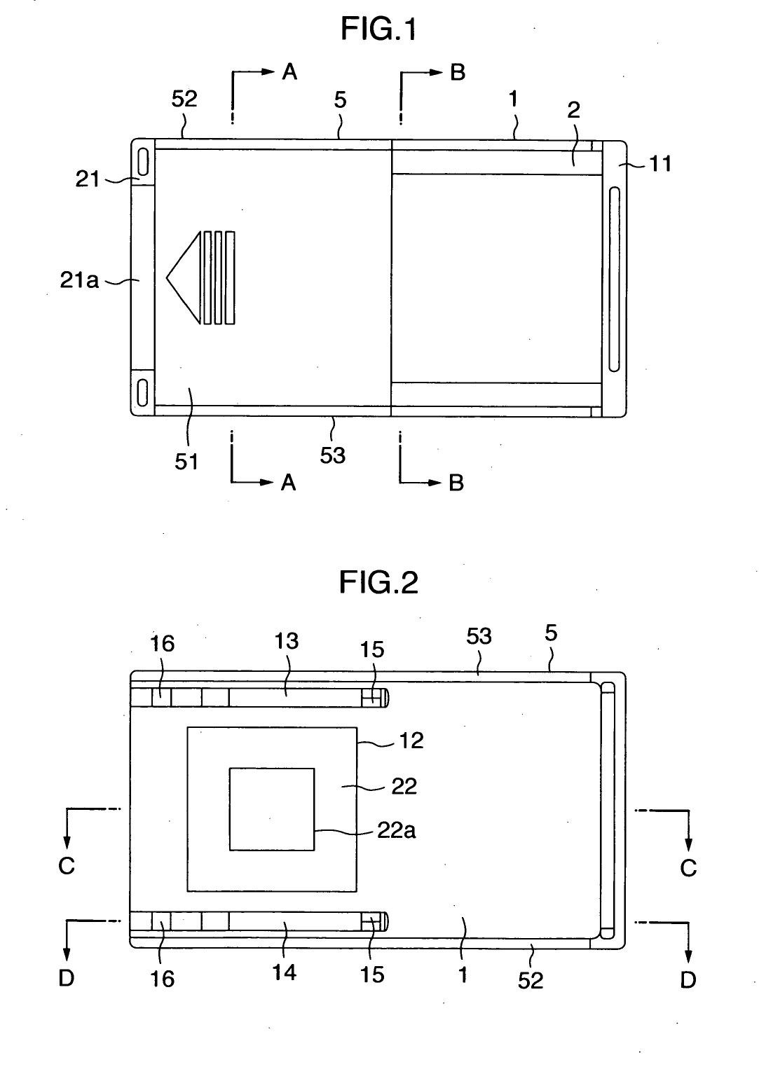

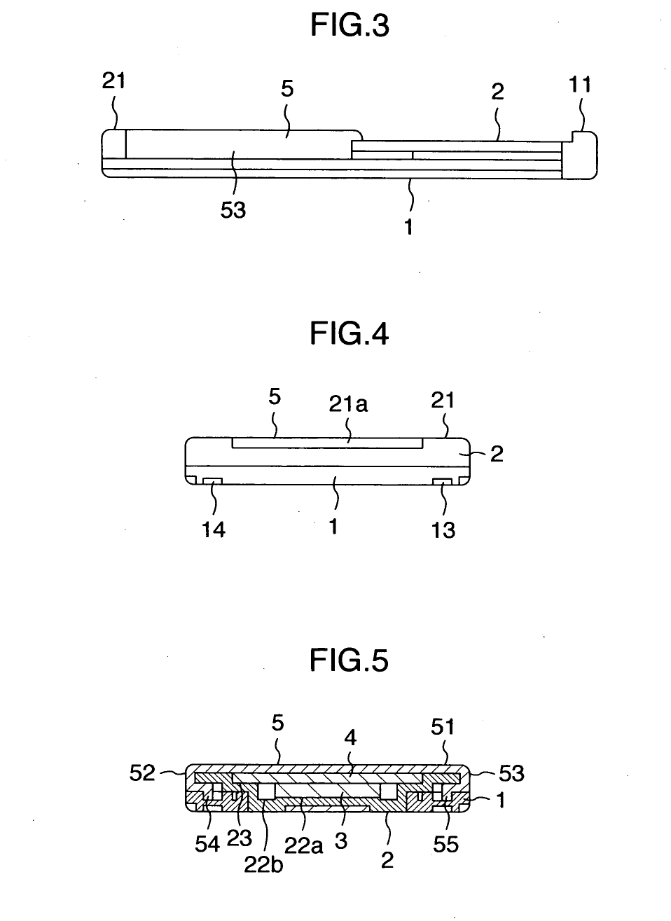

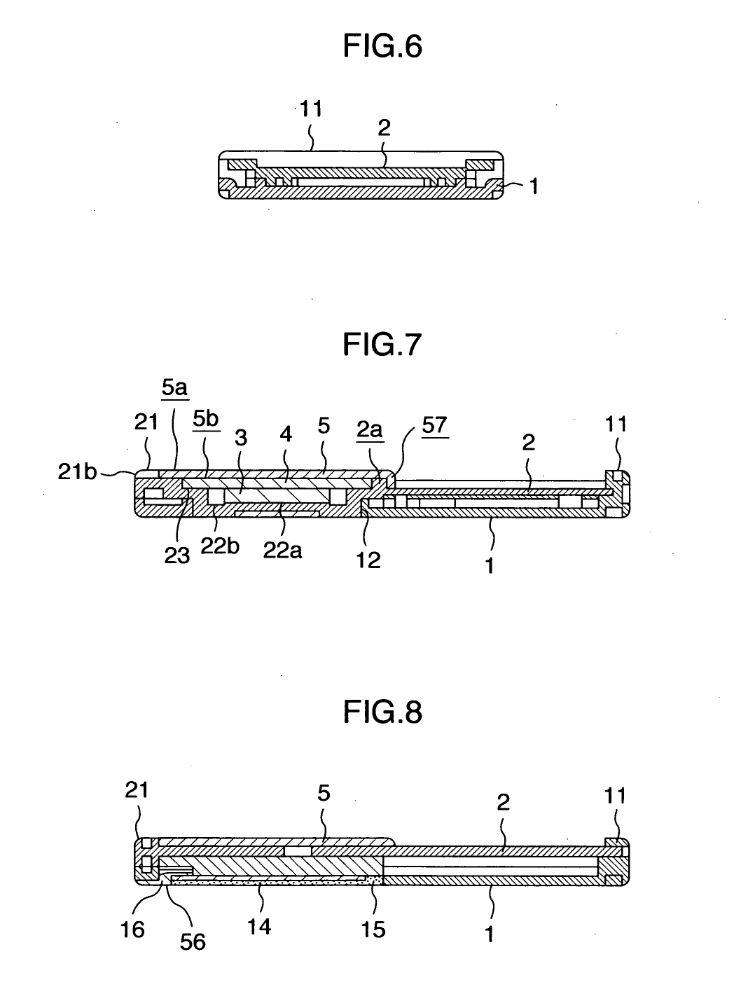

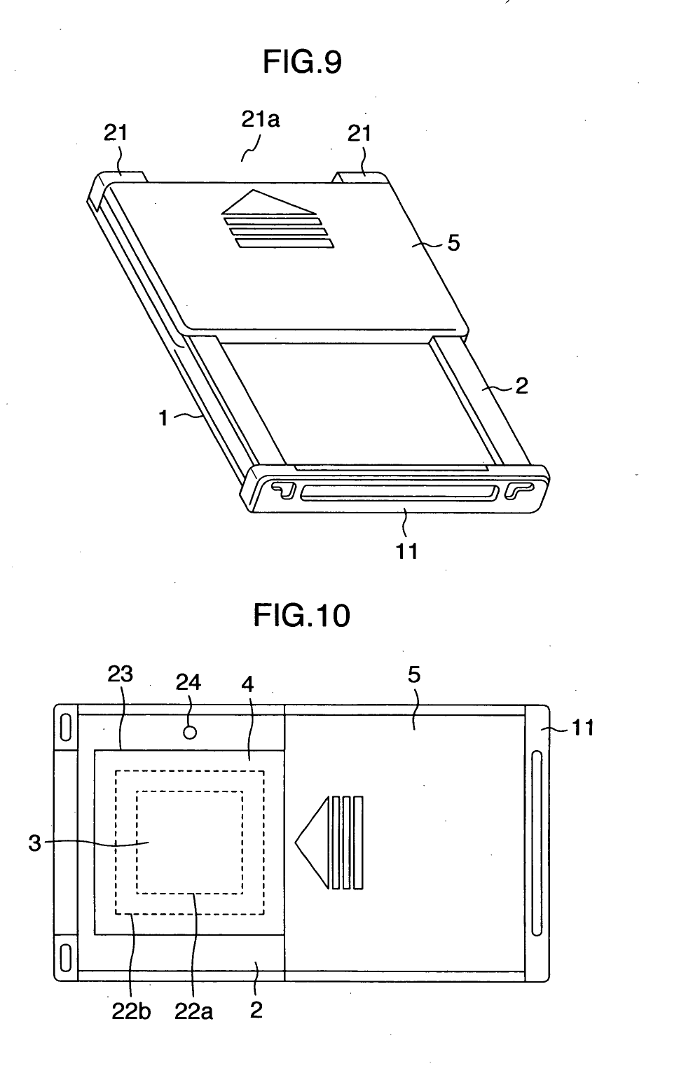

Hereinafter, an embodiment of a hologram medium cartridge according to the present invention will be described with reference to FIGS. 1-10. FIG. 1 is a plane view of the hologram medium cartridge according to the embodiment, FIG. 2 is a back view of the hologram medium cartridge according to the embodiment, FIG. 3 is a side view of the hologram medium cartridge according to the embodiment, FIG. 4 is an end view of the hologram medium cartridge according to the embodiment, FIG. 5 is a cross-sectional view along A-A in FIG. 1, FIG. 6 is a cross-sectional view along B-B in FIG. 1, FIG. 7 is a cross-sectional view along C-C in FIG. 2, FIG. 8 is a cross-sectional view along D-D in FIG. 2, FIG. 9 is a perspective view of the hologram medium cartridge according to the embodiment, and FIG. 10 is a plane view of the hologram medium cartridge according to the embodiment in a shutter open state.

As shown in these figures, the hologram medium cartridge according to this embodiment is composed of a cartridge body 1, a cartridge case 2 mounted to the cartridge body 1, a holographic recording material 3 accommodated in the cartridge case 2, a substrate 4 covering a surface of the holographic recording material 3, and a shutter member 5 slidably mounted to the cartridge case 2.

The cartridge body 1 is formed into a rectangle shape having a predetermined size out of a light-shielding plastic material or the like, and an open side stop part 11 for the shutter member 5 stands on one end in a direction of a long side of the cartridge body 1. In addition, a square through hole 12 for holding the cartridge case 2 in a penetrating state is opened near an end on a side of the cartridge body 1 on which side the open side stop part 11 is not formed. Further, concave grooves 13, 14 are formed to extend in the direction of the long side of the cartridge body 1 in both side portions of the through hole 12 on an inner surface and an outer surface of the cartridge body 1, and through holes 15 for keeping the shutter member 5 in an open side stop position and through holes 16 for keeping the shutter member 5 in a close side stop position are opened in both ends in a longitudinal direction of the concave grooves 13, 14.

The cartridge case 2 is formed into a slightly smaller rectangle shape than the cartridge body 1 out of a light-shielding plastic material or the like, and a close side stop part 21 for the shutter member 5 stands on one end in a direction of a long side of the cartridge case 2. In the center of the close side stop part 21, a notch 21a is provided to insert therein a shutter driving piece (not shown) provided on a recording and reproducing apparatus. In addition, near the end on which the close side stop part 21 of the cartridge case 2 is formed, a square first recess 22 which is inserted in the through hole 12 opened in the cartridge body 1 and a flange-like second recess 23 which is provided on a periphery of the first recess 22 are concentrically formed. The first recess 22 is formed so that its center part is shallow and its surrounding part is deep, and the shallow section in the center part is used as a hologram accommodating recess 22a and the deep section in the surrounding part is used as a hologram storing recess 22b. The flange-like second recess 23 is used as a substrate accommodating recess. Further, in an outer circumferential part of the second recess 23 on a top surface of the cartridge case 2, a reference location mark 24 for indicating a recorded location of the information with respect to the holographic recording material 3 is formed by a depression, as shown in FIGS. 5 and 10.

The cartridge body 1 and the cartridge case 2 are integrated by bringing a tip end of the cartridge case 2 (in which the close side stop portion 21 is not formed) into contact with an inner surface of the open side stop portion 11 formed on the cartridge body 1, and by fitting the first recess 22 formed on the cartridge case 2 into the through hole 12 opened in the cartridge body 1.

The holographic recording material 3 is made of required photosensitive polymer or the like, and accommodated in the hologram accommodating recess 22a formed in the cartridge case 2. The substrate 4 is formed out of glass or plastic which is subjected to required micromachining on its one side, and is accommodated in the second recess 23, namely, in the substrate accommodating recess formed in the cartridge case 2. Accordingly, the holographic recording material 3 it shaped to have a uniform thickness between a bottom surface of the hologram accommodating recess 22a and an inner surface of the substrate 4, so that high performance hologram recording becomes possible. A residual holographic recording material 3 flows into the hologram storing recess 22b.

The shutter member 5 is formed out of a light-shielding plastic material or the like, and composed of a top plate part 51 covering the top surface of the cartridge case 2 in the range of about ½ thereof, side plate parts 52, 53 covering sides of the cartridge case 2, engaging parts 54, 55 which are engaged with concave grooves 17, 18 formed in the cartridge body 1, locking parts 56 which are locked to the through holes 15 or through holes 16 opened in the cartridge body 1 depending on the open and/or close operation of the shutter member 5, and a rib 57 which is formed on a medium side surface 5b of the top plate part 51 of the shutter member 5 in a direction intersecting a sliding direction of the shutter member so as to come into contact with a protruding strip part 2a provided on the cartridge case 2. The material of the shutter member 5 may be a material having a transparent property, or a material having a light-shielding property. Alternatively, it may be a material which shields only the light of a specific wavelength.

Between this shutter member 5 and the cartridge body 1 or the cartridge case 2, a return spring may be provided for constantly biasing the shutter member 5 in a close direction. Further, in order to enhance the light-shielding property, the shutter member may be provided with the side plate parts 52, 53 covering the sides of the cartridge case 2 for the purpose of preventing light from entering through a gap in the sides, and may be provided with the rib 57 on the medium side surface 5b of the top plate part 51 of the shutter member 5 in the direction intersecting the sliding direction of the shutter member so as to come into contact with the protruding strip part 2a which is provided on the cartridge case 2 for preventing light from entering through a gap generating in the sliding direction of the shutter.

Hereinafter, an action of the hologram medium cartridge according to this embodiment configured as described above will be explained.

When the hologram medium cartridge is not used, as shown in FIG. 8, the locking parts 56 of the shutter member 5 are locked to the through holes 16 opened in the cartridge body 1, and one end of the shutter member 5 is hit against the close side stop part 21 formed in the cartridge 2, so that the holographic recording material 3 and the substrate 4 are covered by the shutter member 5. As a result, the holographic recording material 3 is prevented from being exposed, and it becomes possible to store the hologram medium cartridge for a long term. In addition, the light-shielding property during non-operation can be further enhanced by providing the shutter with the side plate parts 52, 53 covering the sides of the cartridge case 2 in order to enhance the light-shielding property for the purpose of preventing light from entering through a gap in the sides, and by providing the medium side surface 5b of the top plate part 51 of the shutter member 5 with the rib 57 in the direction intersecting the sliding direction of the shutter member so as to come into contact with the protruding strip part 2a which is provided on the cartridge case 2 for preventing light from entering through a gap generating in the sliding direction of the shutter.

When recording or reproducing information, by inserting the hologram medium cartridge into the recording and reproducing apparatus while directing the close side stop part 21 to the recording and reproducing apparatus side, the shutter driving piece (not shown) provided on the recording and reproducing apparatus is inserted into the notch 21a formed in the cartridge case 2, and the locking parts 56 formed on the shutter member 5 are elastically deformed by the insertion force of the hologram medium cartridge against the recording and reproducing apparatus, so that the lock between the locking parts 56 and the through holes 16 is released. If the hologram medium cartridge is further pushed into the recording and reproducing apparatus from this condition, the shutter member 5 is gradually opened accordingly, until a tip end of the shutter member 5 hits against the open side stop part 11 formed on the cartridge body 1, so that the shutter member 5 is completely opened. At that time, the locking parts 56 formed on the shutter member 5 are locked to the through holes 15 opened in the cartridge body 1, due to the elasticity of the locking parts 56 itself. Therefore, even after the shutter driving piece is removed from the inside of the hologram medium cartridge, the shutter member 5 is stably kept in its full open position.

In the full open state of the shutter member 5, as shown in FIG. 10, the holographic recording material 3 is exposed through the substrate 4, and the reference location mark 24 is exposed on the top surface of the cartridge case 2. Therefore, by driving an optical system provided in the recording and reproducing apparatus with reference to this reference location mark 24, it becomes possible to record information in a predetermined location on the holographic recording material 3, and reproduce the information recorded in the predetermined location on the holographic recording material 3.

According to the hologram medium cartridge of this embodiment, since the holographic recording material 3 is directly set on the bottom surface of the hologram accommodating recess 22a formed in the cartridge case 2, and the substrate 4 is set on the top surface of the holographic recording material, one of substrates constituting the hologram medium can be omitted so that reduction in thickness and in weight of the hologram medium cartridge can be achieved. In addition, because one of the substrate can be omitted, cost reduction of the hologram medium cartridge can be achieved as a result of decrease in the number of parts and the number of assembling processes.

Further, according to the hologram medium cartridge of this embodiment, since not only the holographic recording material 3 but also the substrate 4 is embedded in the cartridge case 2, it becomes possible to further reduce the thickness of the hologram medium cartridge. In addition, since the substrate accommodating recess 23 operates as a positioning means for the substrate 4 when the hologram medium is mounted in the cartridge case 2, it becomes possible to facilitate the assembling of the hologram medium cartridge.

Further, according to the hologram medium cartridge of this embodiment, since the hologram storing recess 22b is provided around the hologram accommodating recess 22a, it is possible to allow a residual holographic recording material 3 to escape into the hologram storing recess 22b. Therefore, even if the volume of the holographic recording material 3 injected into the hologram accommodating recess 22a varies in some degree, the holographic recording material 3 having a uniform thickness can be always formed over the entire surface of the hologram accommodating recess 22a, and consequently the hologram medium cartridge having required recording characteristics can be manufactured with high yield ratio.

Further, according to the hologram medium cartridge of this embodiment, since the reference location mark 24 for indicating a recording location of information with respect to the holographic recording material 3 is formed on the top surface of the cartridge 2, since it is possible to record information on the holographic recording material 3 accommodated in the cartridge case 2 and to reproduce the information recorded on the holographic recording material 3 with reference to the reference location mark 24, it is possible to perform the recording and the reproducing of the information with high accuracy and high efficiency.

The above described description is made concerning the embodiments, but the present invention is not limited to these, and it is obvious to those skilled in the art to be able to make various changes and corrections within the spirit of the present invention and the scope of the attached claims.

1. A hologram medium cartridge comprising a holographic recording material and a cartridge case accommodating the holographic recording material, wherein
said cartridge case is provided with a hologram accommodating recess for accommodating said holographic recording material, and a surface of said holographic recording material accommodated in said recess is covered with a transparent substrate.

2. The hologram medium cartridge according to claim 1, wherein a substrate accommodating recess is formed on the periphery of said hologram accommodating recess for fitting a periphery of said substrate thereto.

3. The hologram medium cartridge according to claim 1, wherein a hologram storing recess which communicates with said hologram accommodating recess is formed in said cartridge case for accommodating a residual holographic recording material.

4. The hologram medium cartridge according to claim 2, wherein a hologram storing recess which communicates with said hologram accommodating recess is formed in said cartridge case for accommodating a residual holographic recording material.

5. The hologram medium cartridge according to claim 1, wherein a reference location mark is formed on a top surface of said cartridge case for indicating a recording location of information on said holographic recording material.

6. The hologram medium cartridge according to claim 2, wherein a reference location mark is formed on a top surface of said cartridge case for indicating a recording location of information on said holographic recording material.

7. The hologram medium cartridge according to claim 3, wherein a reference location mark is formed on a top surface of said cartridge case for indicating a recording location of information on said holographic recording material.

8. The hologram medium cartridge according to claim 4, wherein a reference location mark is formed on a top surface of said cartridge case for indicating a recording location of information on said holographic recording material.

9. The hologram medium cartridge according to claim 1, further comprising a shutter member attached to the top surface of said cartridge case so as to cover the entire surface of said transparent substrate.

10. The hologram medium cartridge according to claim 2, further comprising a shutter member attached to the top surface of said cartridge case so as to cover the entire surface of said transparent substrate.

11. The hologram medium cartridge according to claim 3, further comprising a shutter member attached to the top surface of said cartridge case so as to cover the entire surface of said transparent substrate.

12. The hologram medium cartridge according to claim 4, further comprising a shutter member attached to the top surface of said cartridge case so as to cover the entire surface of said transparent substrate.

13. The hologram medium cartridge according to claim 5, further comprising a shutter member attached to the top surface of said cartridge case so as to cover the entire surface of said transparent substrate.

14. The hologram medium cartridge according to claim 6, further comprising a shutter member attached to the top surface of said cartridge case so as to cover the entire surface of said transparent substrate.

15. The hologram medium cartridge according to claim 7, further comprising a shutter member attached to the top surface of said cartridge case so as to cover the entire surface of said transparent substrate.

16. The hologram medium cartridge according to claim 8, further comprising a shutter member attached to the top surface of said cartridge case so as to cover the entire surface of said transparent substrate.
